(19) United States
(12) Patent Application Publication
(10) Pub. No.: US 2008/0202856 A1
(43) Pub. Date: Aug. 28, 2008

(54) Angle measurement for forklift operation

(76) Inventors: David Allan Fossier, Loveland, OH (US); William Cherrick, Cincinnati, OH (US)

Correspondence Address: William M. Selenke, 5 Drummond St., Cincinnati, OH, 45218, US

(21) Appl. No.: 12/070,122

(22) Filed: Feb. 15, 2008

Related U.S. Application Data
(60) Provisional application No. 60/902,637, filed on Feb. 22, 2007.

(51) Int. Cl. B66F 9/20

(52) U.S. Cl. 187/224

(57) ABSTRACT

The device measures distance from the forklift mast to a fixed point on the forklift roof (overhead guard) proper. The device has an electronic signal producing source which signal is reflected from a surface on the mast of the forklift. The reflected signal is accepted by a signal receiver. These reflected signals are electronically analyzed and displayed on an analog display device. The display device indicates if the mast is in an upright position or if the mast is forward or rearward from the center. This device is useful for retrieving high bay pallets with goods. The electronic signal is an ultrasonic signal. The electronic signal producing source and receiver may be housed as a single unit.

### FIELD OF INVENTION

The invention is concerned with the safe and efficient operation of industrial forklifts used in warehouses. In particular the present invention is concerned with forklifts that place and retrieve pallet loads of goods from high storage racks (high bay inventory) in warehouses. In particular the invention is concerned that the tines of the forklifts are level with the warehouse floor. That is when the forklift operator raises the tines to a high level, in excess of 30 feet and urges the forklift with the raised tines into the 3 to 4 inch wide hollow of the pallet, those tines must be level and parallel with the core of the pallet load. The present invention describes an inventive method by which the forklift operator will know that the tines inserted into the core of the pallet are level with the pallet.

### BACKGROUND OF INVENTION

The quick and efficient storage and transport of large quantities of goods uses palletized loads. That is goods are secured on pallets or skids.

A common pallet type is a stringer pallet. Stringer pallets are manufactured frame with three parallel pieces of timber (called stringers). The top deckboards are then affixed to the stringers to create the pallet structure with a hollow below the deckboards. Stringer pallets are also known as “two-way” pallets, since a pallet-jack may only lift it from two directions instead of four. Forklifts can lift a stringer pallet from all four directions, though lifting by the stringers is more secure.

The mechanism to secure and move the pallet using a forklift requires three parts of the forklift: the mast, the carriage, and the forks with tines parallel to the floor. Note the mast is attached to the body or front axle of the forklift (tow motor). An attachment called a carriage is movably secured to the mast. An hydraulic system controlled by the forklift driver can activate the hydraulic system of the mast-carriage and move the carriage with its attached fork-tines up or down. Thus the forklift operator approaches the pallet load perpendicularly. He moves the carriage with attached tines to the proper height to access the hollow of the pallet.

Once the tines are safely within the hollow of the pallet the forklift operator can raise the tines lifting the load from its storage spot. By reversing the forklift proper the load is removed from its spot and can be moved to another place to which the pallet load is desired. In many operations the pallet loads are either on the floor or only a few feet above the level floor on which the forklift operates. Under these circumstances it is relatively easy for the forklift operator to place the tines within the hollow of the pallet.

For most forklifts the mast with its carriage can be moved up to 5° away from perpendicular so that the load rests against the mast with attached carriage. When not in use the forklift mast is tilted forward into the “park position.” The “park position” reduces injures caused by workers tripping over raised tines.

However, a subclass of forklifts has quite tall masts. These tall masts require the forklift operator to raise tines to some tens of feet high in the warehouse (high bay). As mentioned above the mast can be moved from its attachment base up to a 5° angle. If the load is stacked fifteen or more feet above the floor the 5° angle can create a large movement for the ends of the fork tines. The times must be almost level with the floor to safely insert the tines into the 3 to 4 inch wide hollow of the pallet.

If the tines are not accurately placed within the hollow of the pallet, undesired action can occur. That is the tines with the large mass force of the forklift can easily damage the pallet and the goods on the pallet. In other cases the tines can dislodge neighboring pallets, which pallets falling from fifteen or twenty feet can cause serious damage and injury to other workers. For this reason it is desirable the operator of the forklift know that his mast is truly perpendicular to the floor so that the attached times are level with the floor.

This problem has been addressed in patented and unpatented art. Cascade Corporation has a commercially available system that is mated with the hydraulic controls of the mast. The system is automatic and is relatively expensive. U.S. Pat. No. 6,941,666 to Parish teaches a mechanical pendulum system with mechanically displayed indices. U.S. Pat. No. 5,749,696 to Johnson teaches a tape system to inform the operator of the height and angle of the forks. U.S. Pat. No. 5,697,755 to McCauley teaches a mechanical linkage system to indicate the angle of the mast. These three patents have a common problem. Forklifts operate in a fast paced relatively dirty environment. By definition, mechanical devices can bind and distort, leading to false readings. These problems can be lessened by constant maintenance. U.S. Pat. No. 5,131,801 to Melanson teaches a mechanical system attached to the hydraulic cylinder. The position of the mechanical system is monitored and displayed electronically. The present invention provides a electronic/ultrasonic means of determining the angle of the mast of forklifts.

### SUMMARY OF INVENTION

The invention is a device which measures distance from the forklift mast to a fixed point on the forklift proper. It has an electronic signal producing source, a reflecting surface and a receiving means for the electronically produced source. The invention has an electronic means of analyzing the electronic signal and a display module to show the processed signal. The electronic signal producing source, the receiving means, and the electronic analyzing means are attached to the body of the forklift proper. The display module is placed to be within the driver compartment. The reflecting surface is on the forklift (workpiece) mast. When the produced signal is reflected from the reflecting surface on the workpiece mast. The reflected signal is captured by the electronic means of analyzing the reflected signal and the reflected signal is electronically analyzed. The electronically analyzed signal illuminated on the display module so that the forklift driver knows the precise angle of the forklift mast.

The electronic signal producing source and the receiving means for the electronically produced source are housed as a single unit and the signal producing source is an ultrasonic generator and the receiving means is an ultrasonic receiver.

The display module for the invention is an analog system. The analog system is a series of lights, including one single green LED when mast is in a perpendicular position. When the mast is relatively distal from the perpendicular position a single yellow LED is activated, when the mast is further distal from the perpendicular position two yellow LED's are activated, and when the mast is at a more extreme distal angle from the perpendicular position three yellow LED's are activated. In contrast, when the mast is relatively proximal to center from the perpendicular position a single red LED is activated, when the mast is closer to center from the perpendicular position to a greater degree the two red LED's are activated, and when the mast is at the most extreme angle to center from the perpendicular position toward to the center three red LED's are activated.

### BRIEF DESCRIPTION OF FIGURES

FIG. 1 shows a current art diagram of a forklift in an exploded diagram.

FIG. 2 shows a diagram of current art forklift proper assembled.

FIGS. 3 A,B, and C illustrate the problem encountered as the carriage with forks are raised to heights necessary to retrieve pallets stored high in warehouse shelves.

FIG. 4 shows the components of the invention.

FIG. 5 is an amplified view of the portion of FIG. 1 which encompasses the features enclosed by circle A.

FIG. 6 shows details of preferred embodiment display unit.

### DETAILED DESCRIPTION OF FIGURES

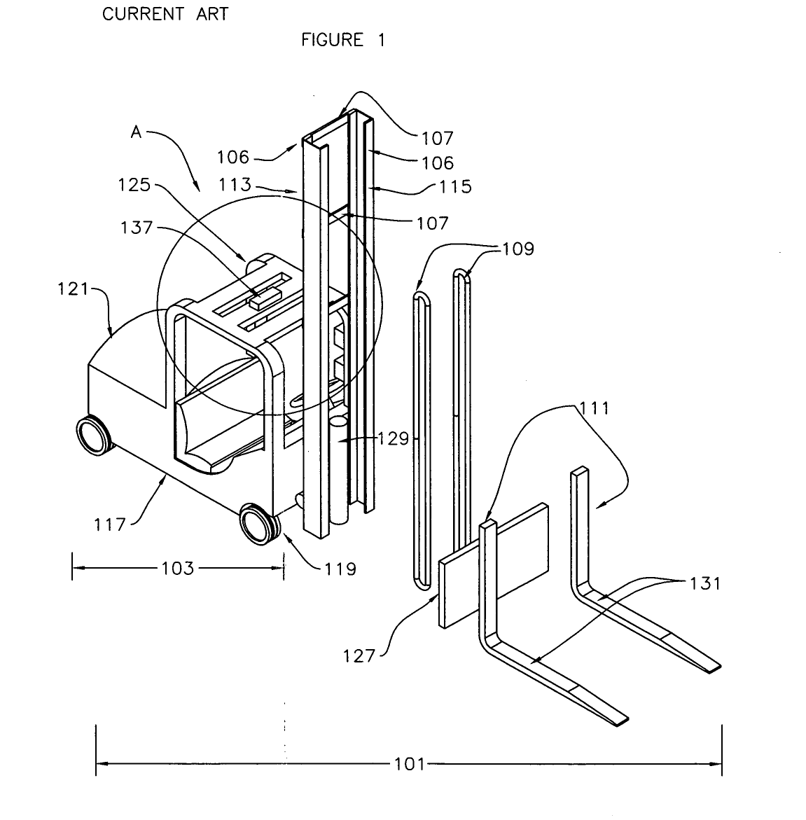

FIG. 1 shows a current art diagram of a forklift 101 with mast 106, carriage 109 and forks 111 in an exploded diagram. Forklift proper 103 is shown. The mast 103 with two sides 113 and 115 are bound together by crossheads 107. mast 103 is attached to either the frame 117 or front wheels 119. The engine/counterweight compartment is 121. The overhead guard 125 protects the driver. The carriage 109 is moved up and down the mast by hydraulic cylinders and/or chains 129. Forks 111 with tines 131 pass into the hollow of pallets.

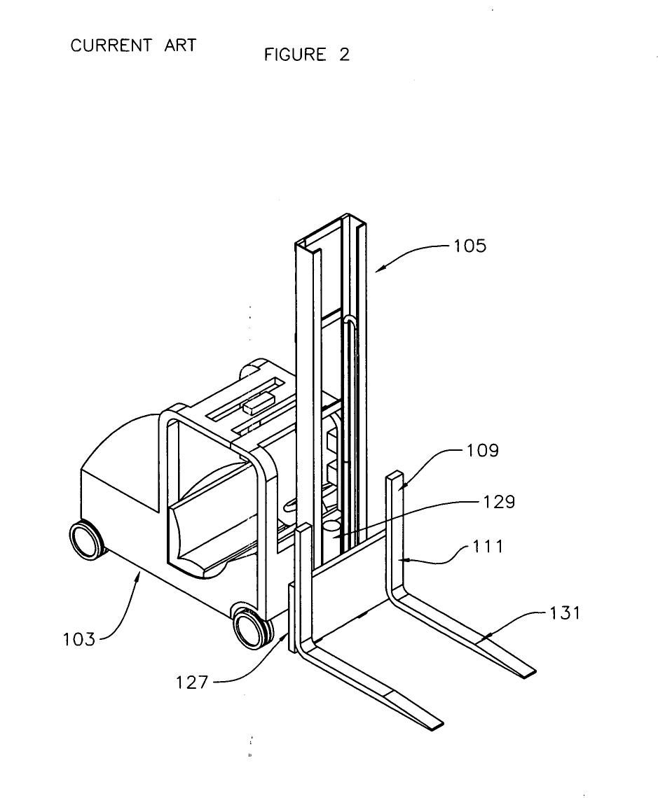

FIG. 2 shows a diagram of forklift proper 103 with attached mast 105, carriage 109, and forks 111 with tines 131. This diagram illustrates a forklift assembled and ready for work.

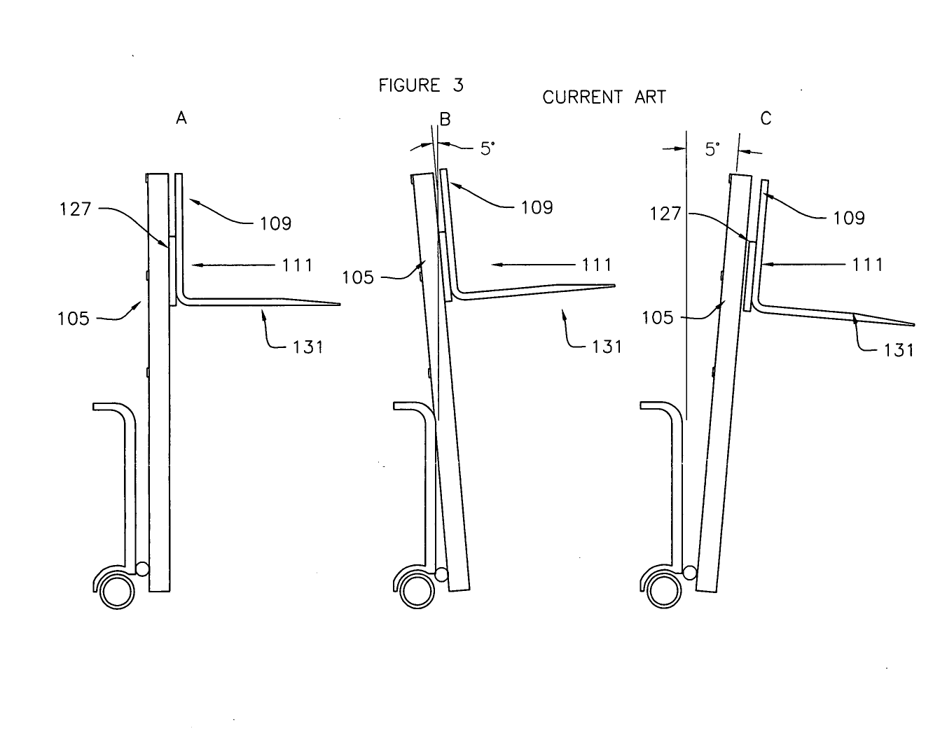

FIGS. 3 A,B, and C illustrate the problem encountered as the carriage with forks are raised to heights necessary to retrieve pallets stored high in warehouse shelves. A shows mast 105 with carriage 109 raised to hit near maximum height. Since the mast is at a 90° angle the tines 131 of fork 111 are level. Thus the tines 131 of fork 111 are level with the warehouse floor and the tines 131 can penetrate the hollow of pallets without serious damage to the pallet or loaded pallet goods. B illustrates that the mast can be moved 5° rearward over the cab of the forklift. This moves the center of gravity of the load to a more nearly center of mass. The load at this 5° rearward angle is the lowered prior to movement. It is a common practice that all pallet loads are moved with the mast at a 5° rearward angle.

However, if the mast is at a rearward angles such as the mentioned 5° rearward angle the forklift tine do not go straight into the hollow of the pallet. This can damage the pallet, damage the pallet goods, or push an adjoining pallet off of the rack causing much damage and potential injury.

C illustrates the actions of ordinary forklifts in that the mast 105 with carriage 109 and fork 111 tines 131 can be moved forward lowering the points of the tines. Ordinarily the idle forklifts have the mast placed forward so that the tines are flat with the floor. When the tines are flat they are less obtrusive and less likely to cause a worker to stumble and fall. However since mast 105 can be moved 5° rearward as in B and 5° forward as in C so that even a small angle at 20 to 30 feet above the forklift can magnify the effect of the mast movement.

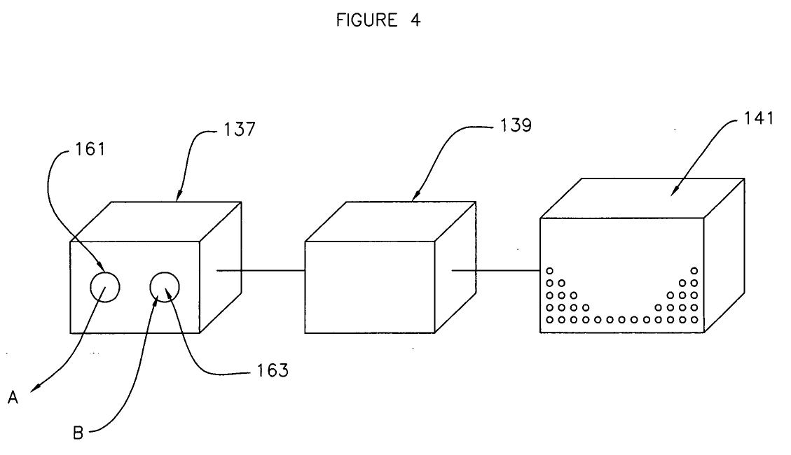

The components of the invention are shown in FIG. 4. Ultrasonic sender/receiver (sensor) 137 is mounted on overhead guard 125. The signals from ultrasonic sender 161 (arrow A shows the outward signal) and receiver 163 (Arrow B shown reflected signal). This information is electronically transferred to a base unit 139. Base unit analyzes the signals and the magnitude of the signals is displayed on display unit 141.

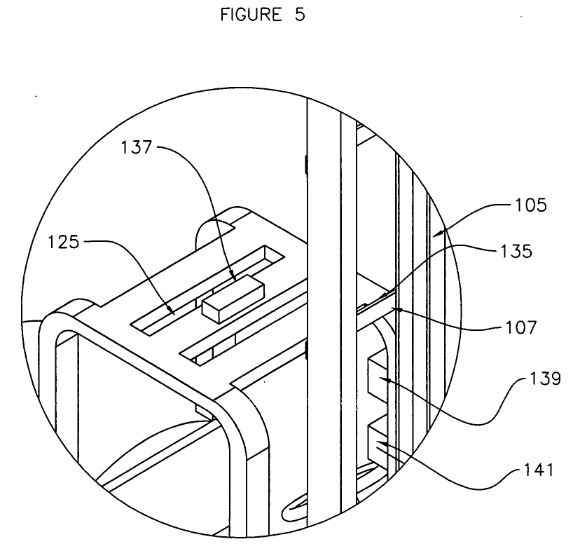

FIG. 5 is an amplified view of the portion of FIG. 1 which encompasses the features enclosed by circle A. mast 105 with crosshead 107 is shown. On the side facing the overhead guard 125 is reflector 135 (not shown). Reflector can be any flat surface, including the surface of crosshead 197. If necessary an alternative reflecting surface may be installed. Ultrasonic sender/receiver (sensor) 137 is mounted on overhead guard 125. The signals from ultrasonic sender/receiver (sensor) 137 are electronically transferred to a base unit 139. Base unit analyzes the signals and transfers the signals to display unit 141. The magnitude of the signals is shown on display unit 141.

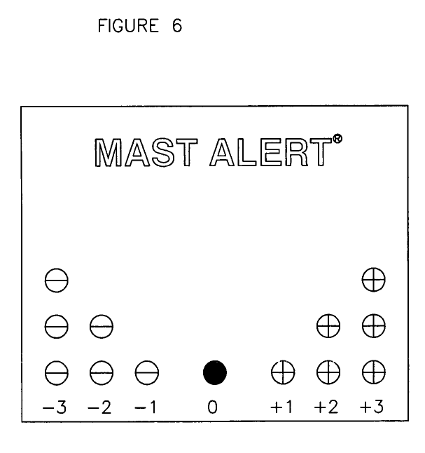

FIG. 6 shows details of preferred embodiment display unit 141. Display unit 141 show the relative angle of the mast. The display 141 is a simple analog readout. If the angle is perpendicular or 90° (also labeled as 0) the display shows a single green dot 145 illuminated by a LED. If the mast is relatively distal to center a single yellow LED 147 is shown. If the mast is further distal from center two yellow LED's 149 are activated. Likewise, if the mast is in a more extreme angle distal from center three yellow LED's 151 are activated.

On the other hand, if the mast is relatively proximal to the center a single red LED 153 is shown. If the mast is closer to the center to a greater degree, two red LED's 155 are activated. Likewise, if the mast a more extreme angle toward the center three red LED's 157 are activated. The forklift operator is readily informed of the angle of his mast with a quick glance. Of course these colors of the preferred embodiment are arbitrary. The Mast Alert measures the distance from the target and the sensor. The display indicates a center (0 degree or vertical position) that is programmed when the system is installed. The other indicators are illuminated when this distance changes by 0.3″ or more relative to the programmed 0 point.

We claim:

1) A device to measure distance from the forklift mast to a fixed point on the forklift proper comprising:
an electronic signal producing source,
a reflecting surface;
a receiving means for the electronically produced source;
an electronic means of analyzing the electronic signal;
a display module to show the processed signal;
wherein the electronic signal producing source, the receiving means, the electronic analyzing means are affixed to the body of the forklift proper,
the display module is placed to be within the driver compartment;
the reflecting surface is on workpiece mast;
where in the produced signal is reflected from the reflecting surface on the workpiece mast;
the reflected signal is captured by the electronic means of analyzing the reflected signal;
the reflected signal is electronically analyzed;
said electronically analyzed signal illuminated on the display module so that the forklift driver knows the precise angle of the forklift mast.

2) A device to measure distance from the forklift mast as in claim 1) wherein the electronic signal producing source and the receiving means for the electronically produced source are housed as a single unit.

3) A device to measure distance from the forklift mast as in claim 1) wherein the signal producing source is an ultrasonic generator and the receiving means is an ultrasonic receiver.

4) A device to measure distance from the forklift mast as in claim 1) wherein the display module is an analog system.

5) A device to measure distance from the forklift mast as in claim 4) wherein the analog system is a series of lights;
the series of light include one single green LED when mast in a perpendicular position;
when the mast is relatively distal from the perpendicular position a single yellow LED is activated;
when the mast is further distal from the perpendicular position two yellow LED's are activated;
when the mast is at a more extreme distal angle from the perpendicular position three yellow LED's are activated;
in contrast, when the mast is relatively proximal to center from the perpendicular position a single red LED is activated;
when the mast is closer to center from the perpendicular position to a greater degree the two red LED's are activated;
and when the mast is at the most extreme angle to center from the perpendicular position toward to the center three red LED's are activated.
